(19) United States
(12) Patent Application Publication
(10) Pub. No.: US 2018/0341993 A1
(43) Pub. Date: Nov. 29, 2018

(54) SENSOR-BASED INTERACTION ANALYTICS

(71) Applicant: International Business Machines Corporation, Armonk, NY (US)

(72) Inventors: James E. Bostick, Cedar Park, TX (US); Danny Y. Chen, Austin, TX (US); Sarbajit K. Rakshit, Kolkata (IN); Keith R. Walker, Austin, TX (US)

(21) Appl. No.: 15/851,948

(22) Filed: Dec. 22, 2017

Related U.S. Application Data
(63) Continuation of application No. 15/603,522, filed on May 24, 2017.

(51) Int. Cl. G06Q 30/02

(52) U.S. Cl. CPC G06Q 30/0282

(57) ABSTRACT

In an approach to sensor-based interaction analytics, one or more computer processors receive user interaction data associated with a product and product features. The one or more computer processors identify one or more features of the product corresponding to the user interaction data. The one or more computer processors associate the user interaction data with a product and a product feature. The one or more computer processors establish a baseline of user interaction data associated with an average user response to the product and the product feature. The one or more computer processors analyze the received user interaction data associated with the product and product features. In response to determining that a deviation from the average user response has occurred, the one or more computer processors create a deviation report containing the received and associated product feature.

### BACKGROUND OF THE INVENTION

The present invention relates generally to the field of data analytics, and more particularly to sensor-based data analytics.

Analytics involves the processing of data to extract meaningful patterns. Applying statistics and computer programming to data processing allows for software programs to come to meaningful conclusions about the raw data. Different data sources may yield different conclusions. Applying analytics to sensor data, such as microphones, cameras, and gyroscopic sensors, allows for software programs to make determinations regarding a user's behavioral characteristics associated with a product or product features. For example, visual data, auditory data, and gyroscopic data may be analyzed to form conclusions about the emotional state of a user when using a particular feature of a product.

### SUMMARY

Embodiments of the present invention disclose a method, a computer program product, and a system for sensor-based interaction analytics. The method may include one or more computer processors receiving user interaction data associated with a product and one or more product features of the product. The one or more computer processors identify one or more features of the product corresponding to the user interaction data. The one or more computer processors associate the user interaction data with a product and one or more product features. The one or more computer processors establish a baseline of user interaction data associated with an average user response to the product and the one or more product features. The one or more computer processors analyze the received user interaction data associated with the product and the one or more product features determine if a deviation from the average user response has occurred. In response to determining that a deviation from the average user response has occurred, the one or more computer processors create a deviation report containing the received and associated one or more product features. The one or more computer processors send the deviation report containing the user interaction data exceeding the maximum tolerable deviation threshold.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of an interaction assessment program, on a server computer within the distributed data processing environment of FIG. 1, for identifying deviation from an average user response to a product and a product feature of the product, in accordance with an embodiment of the present invention;

FIG. 3 depicts a block diagram of components of the server computer executing the interaction assessment program within the distributed data processing environment of FIG. 1, in accordance with an embodiment of the present invention;

FIG. 4 depicts a cloud computing environment according to an embodiment of the present invention; and

FIG. 5 depicts abstraction model layers according to an embodiment of the present invention.

### DETAILED DESCRIPTION

The present day prevalence and rapid expansion of the sensing capabilities of client devices allows for the application of analytics to new types of data gathered from various sensor arrays. As such, the flow and use of information essential to improving a user experience can benefit from the application of analytics to new categories of data, such as data from microphones, cameras, pressure sensors, gyroscopic sensors, and biometric sensors, identified using the expanded capabilities of modern client devices. By applying analytics to electromagnetic noise signal detection, an improved user experience is possible. For example, the detection and recording of unique movement, facial expression, and biometric data associated with a client device provides analytics programs with detailed information about the specific objects a user interacts with on a day to day basis, such as stoves, refrigerators, computers, and electromechanical devices. As a result, a sensor-based analytics program can make specific inferences based on user activity patterns associated with particular devices to provide relevant information to the manufacturer. Embodiments of the present invention recognize that utilizing sensor data improves the efficacy of analytics by providing more relevant information to the manufacturer and better managing a technological ecosystem. Implementation of embodiments of the invention may take a variety of forms, and exemplary implementation details are discussed subsequently with reference to the Figures.

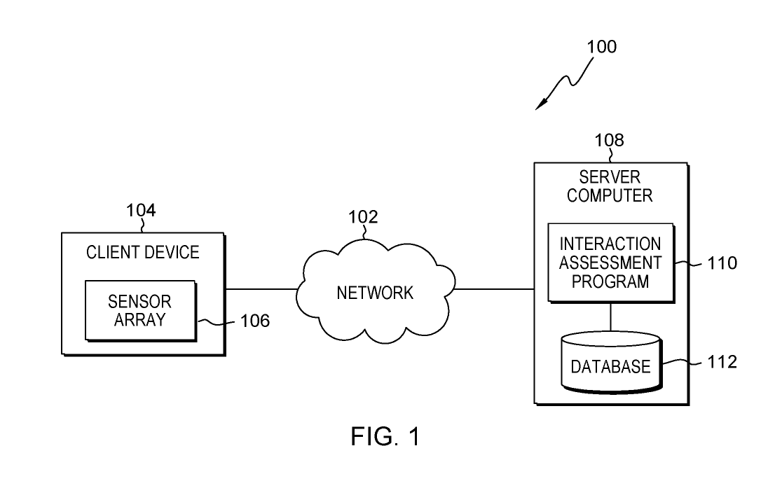

FIG. 1 is a functional block diagram illustrating a distributed data processing environment, generally designated 100, in accordance with one embodiment of the present invention. The term “distributed” as used in this specification describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes client device 104 and server computer 108 interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between client device 104 and server computer 108, and other devices (not shown) within distributed data processing environment 100.

Client device 104 can be any programmable electronic client device operatively coupled to one or more sensors capable of communicating with various components and devices, such as a laptop computer, a tablet computer, or a smart phone, within distributed data processing environment 100, via network 102. In general, client device 104 represents any programmable electronic client device or combination of programmable electronic client devices capable of executing machine readable program instructions, manipulating executable machine readable instructions, collecting sensor data, and communicating with server computer 108 and other client devices (not shown) within distributed data processing environment 100 via a network, such as network 102. Client device 104 is operatively coupled an instance of sensor array 106. Client device 104 and sensor array 106 allow interaction assessment program 110 to analyze sensor data associated with a series of interactions with client device 104 to specify and collect statistics on which particular features of a device cause frustration for users and recommend features requiring modification. In one embodiment, client device 104 may be a personal computing device operatively coupled to a sensor array 106. For example, client device 104 may be a smart phone operatively coupled to a front-facing camera, a rear-facing camera, a gyroscopic sensor, a light sensor, and a biometric sensor. In another example, client device 104 may be a smartwatch operatively coupled to a heart rate monitor, a gyroscopic sensor, a geolocation sensor, and a capacitive touch sensor. In another embodiment, client device 104 may be an internet-connected electromechanical device operatively coupled to a sensor array 106. For example, client device 104 may be an internet-connected refrigerator operatively coupled to a temperature sensor, a pressure sensor, and a capacitive touch sensor. In yet another example, client device 104 may be an internet connected television remote operatively coupled to a gyroscopic sensor, a pressure sensor, and a microphone.

Sensor array 106 provides interaction data to interaction assessment program 110 on server computer 108 for a user of client device 104. Sensor array 106 may include any combination of sensors, such as microphones, cameras, pressure sensors, gyroscopic sensors, and biometric sensors. Sensor array 106 may be present on client device 104 or may be located outside of client device 104. Sensor array 106 may be comprised of any combination of sensors located inside or outside client device 104, such as one or more sensors in the same location or multiple sensors in different locations. Sensor array 106 may be comprised of multiple sensors working in concert with each other or independently of each other. Sensor array 106 may be paired with a mobile application software that communicates between a client device 104 and interaction assessment program 110 on server computer 108. Mobile application software, or an “app,” is a computer program designed to run on smart phones, tablet computers and other mobile devices.

In one embodiment, sensor array 106 may be one or more sensors located outside of client device 104. For example, a consumer research lab may use multiple microphones and video cameras around new products to capture consumer feedback. In another embodiment, sensor array 106 may be multiple sensor arrays 106 located on multiple client devices 104 working cooperatively. For example, a research agency may provide an app for a smartphone to capture real time seismic data from a gyroscopic sensor located in each smartphone with the app installed. In another example, a management team may attach a sensor array 106, such as a small device containing a gyroscopic sensor and microphone, to various objects around an office, such as printers, laptops, and vending machines, to gather data on sources of frustration around the office. In another embodiment, sensor array 106 may be one or more sensors physically connected to client device 104. For example, sensor array 106 may be a gyroscopic sensor, a camera, and a microphone inside a smartphone. However, sensor array 106 may be any one or more sensors operatively coupled to one or more client devices 104.

Server computer 108 can be a standalone client device, a management server, a web server, a mobile client device, or any other electronic device or computing system capable of receiving, sending, and processing data. For example, server computer 108 may be a network-connected management server owned by a manufacturer to receive and process consumer interaction data with a product for research and development purposes. In another example, server computer 108 may be a clustered computer owned by a consumer research company which provides a smartphone app that collects user interaction data from one or more users of one or more products from one or more companies, such as smartphone manufacturers.

In other embodiments, server computer 108 can represent a server computing system utilizing multiple computers as a server system, such as in a cloud computing environment. For example, server computer 108 may be a network of server computers owned by a state for receiving and processing data collected from residents of the state. In another example, server computer 108 may be one or more client devices 104 capable of processing data working together to process data collected from the one or more client devices 104, such as processing data from multiple smartphones with the same make and model which collect user interaction data to troubleshoot user interface issues on the smartphone using one or more sensors. In another embodiment, server computer 108 can be a laptop computer, a tablet computer, a netbook computer, a personal computer (PC), a desktop computer, a personal digital assistant (PDA), a smart phone, or any other programmable electronic device capable of communicating with client device 104 and other client devices (not shown) within distributed data processing environment 100 via network 102. In another embodiment, server computer 108 represents a computing system utilizing clustered computers and components (e.g., database server computers, application server computers, etc.) that act as a single pool of seamless resources when accessed within distributed data processing environment 100.

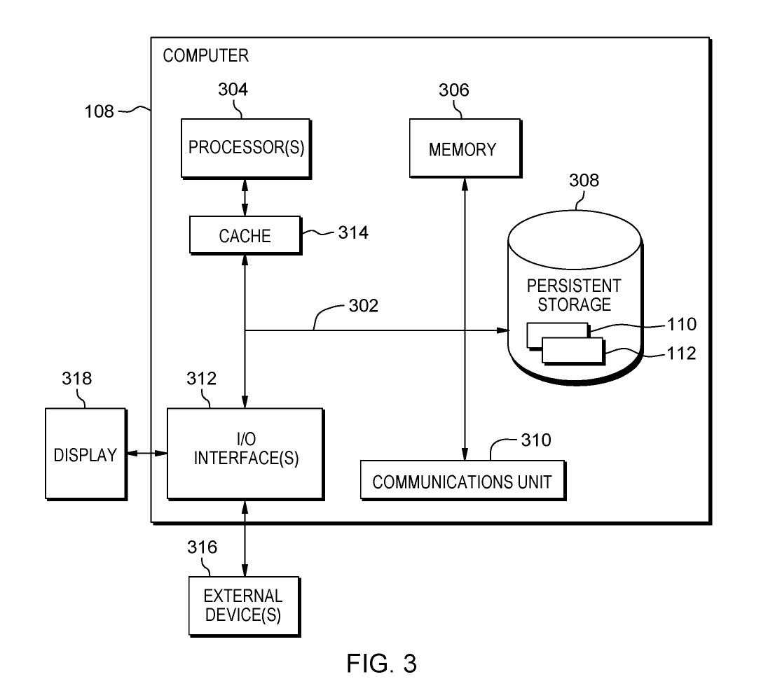

Server computer 108 includes interaction assessment program 110 and database 112. Server computer 108 may include internal and external hardware components, as depicted and described in further detail with respect to FIG. 3.

Interaction assessment program 110 initiates shortly after a user interacts with client device 104 in a manner indicating a deviation from an average user response. In one embodiment, an average user response may be an expected user response determined by an analysis of historical user interaction data associated with the user. In another embodiment, a user of interaction assessment program 110 may establish the parameters defining an average user response. Parameters may include any measurable variable, such as time, force, movement, decibels, and image analysis. For example, a manufacturer may set the parameters defining normal user behavior as a smartphone accelerometer sensing fewer than ten instances of the gravitational force (G-force) exceeding five Gs within a six second time frame before registering as a deviation from an average user response. Once sensor array 106 detects user interaction data, interaction assessment program 110 initiates once interaction assessment program 110 receives user interaction data associated with a deviation from an average user response. For example, interaction assessment program 110 may receive user interaction data from a smartphone indicating that a user shook the phone in a more forceful way than associated with an average user response. In another example, interaction assessment program 110 may receive user interaction data from a smartphone indicating that the decibel level of a user's voice exceeded a decibel range associated with an average user response.

Following the receipt of user interaction data, interaction assessment program 110 associates the user interaction data with a product and one or more product features. For example, the source may be a home appliance and a particular feature of the home appliance associated with the product causing a user to behave or use the product in a manner deviating from an average user response associated with the product. Interaction assessment program 110 records the user interaction data associated with the product and the one or more product features. For example, interaction assessment program 110 may record the user interaction data associated with a product and a product feature of the product on a hard drive located on a server computer.

Interaction assessment program 110 analyzes the received user interaction data associated with the product and the one or more product features determine if a deviation from the average user response has occurred. Interaction assessment program 110 determines a maximum tolerable deviation threshold. A maximum tolerable deviation threshold is the extent to which user interaction data can deviate from a baseline user interaction characteristic. For example, interaction assessment program 110 may determine that a maximum tolerable deviation threshold for a particular feature of a product is two percent of the time in a period of one year. In another embodiment, a user of interaction assessment program 110, such as a product manufacturer, may determine the maximum tolerable deviation threshold. For example, a remote manufacturer for an internet connected streaming device may determine that the maximum tolerable deviation threshold is three instances per week.

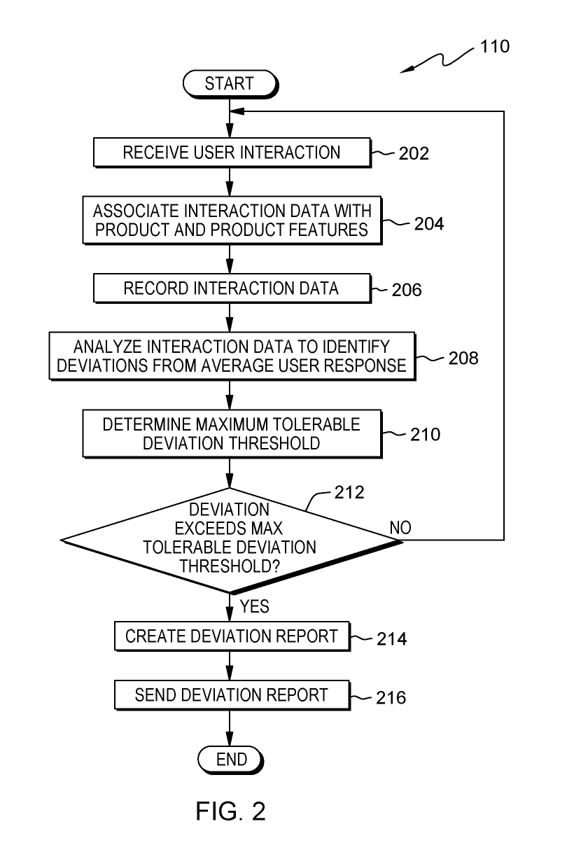

Interaction assessment program 110 determines whether or not the deviating feature exceeds the maximum tolerable deviation threshold. Responsive to determining that the deviating feature does not exceed the maximum tolerable deviation threshold, interaction assessment program 110 returns to receive subsequent user interaction data. Responsive to determining that a deviation from the average user response has occurred, interaction assessment program 110 creates a deviation report containing the received user interaction data and associated one or more product features. A deviation report may include any one or combination of metrics relevant to identifying and assisting in fixing the deviating features associated with the product. Interaction assessment program 110 sends one or more deviation reports containing the received user interaction data and associated one or more product features to a user of interaction assessment program 110. Interaction assessment program 110 is depicted and described in further detail with respect to FIG. 2.

Database 112 is a repository for data used and stored by interaction assessment program 110. In the depicted embodiment, database 112 resides on server computer 108. In another embodiment, database 112 may reside elsewhere within distributed data processing environment 100 provided interaction assessment program 110 has access to database 112. A database is an organized collection of data. Database 112 can be implemented with any type of storage device capable of storing data and configuration files that can be accessed and utilized by server computer 108, such as a database server, a hard disk drive, or a flash memory. Database 112 may store user interaction data, product data, product feature data, deviation reports, and any other relevant data associate with a client device, such as client device 104. Database 112 also stores data and parameters, such as maximum tolerable deviation thresholds of a product and associated product feature, inputted by a user of client device 104 for the purpose of controlling how interaction assessment program 110 narrows down the circumstances surrounding the deviation from an average user response. Database 112 may also store data associated with the historical user interaction data, product data, product feature data, and deviation reports of client device 104.

FIG. 2 is a flowchart depicting operational steps of interaction assessment program 110, on server computer 108 within distributed data processing environment 100 of FIG. 1, a program for analyzing user interaction data surrounding a product feature associate with a product, in accordance with an embodiment of the present invention. Interaction assessment program 110 starts after a user interacts with client device 104 in a negative manner, such as a manner indicating frustration. Interaction assessment program 110 continues to run until interaction assessment program 110 creates and sends one or more deviation reports to a user of interaction assessment program 110 detailing the circumstances of a negative user interaction.

Interaction assessment program 110 receives user interaction data associated with a deviation from an average user response (step 202). In one embodiment, a deviation from an average user response may be associated with an unfavorable reaction, such as anger or frustration, by a user to a product feature. In another embodiment, a deviation from an average user response may be associated with a favorable reaction, such as happiness or excitement, by a user to a product feature. Based on the sensors available in sensor array 106, a deviation from an average user response may be detected in a variety of ways. For example, a gyroscopic sensor may register movement indicating sudden harsh shaking movements. In another example, a microphone may detect elevated decibel levels, increased speed of speech, and profanity present in a deviation from an average user response. In yet another example, a biometric sensor may detect an elevated heart rate and levels of cortisol in the blood stream.

In yet another example, a microphone may detect vocal characteristics indicating any variety of emotions, such as a low pitch downwards inflection indicating anger, high pitch and pace of speech indicating happiness, and a high pitch and high decibel level indicating excitement. In yet another example, a capacitive touch screen with haptic feedback may detect a significantly higher than normal pressure associated with each tap of an icon and a high rate of tapping on the screen which may indicate frustration with a non-responsive icon. In yet another example, a camera may detect a change in facial expressions indicating any variety of emotions, such as a mouth shape indicating a frown, a mouth shape indicating happiness, the presence of exposed teeth indicating laughter, and furrowed brows indicating frustration. However, sensor array 106 may capture user interaction data in any method available using one or more sensors. Once sensor array 106 registers a deviation from an average user response, interaction assessment program 110 may receive the raw data through network 102 for further analysis.

Interaction assessment program 110 associates the user interaction data with the source of the deviation from an average user response, such as product data and product feature data of the product (step 204). Product data may include the identity of a user device and model of the user device serving as the source of the deviation from an average user response. For example, product data may include the manufacturer and particular model of a user device, such as the release year and model of a smartphone or a television remote. Product feature data may include the particular feature associated with a product that causes the deviation from an average user response. For example, a product feature may include features such as programs, program functions, and physical features, such as buttons on a smartphone. In one embodiment, interaction assessment program 110 may associate the user interaction data with a particular product feature on a product. For example, the product feature may be a camera shutter button on a smartphone that causes a deviation from an average user response when the shutter button fails to register a button press through a capacitive touch screen. In another example, the product feature may be a physical home button on a smartphone that returns the screen to a default menu that causes a deviation from an average user response when the home button fails to function properly. In another example, the product feature may be a mini game in a smartphone video game that causes a deviation from an average user response by registering particular vocal inflections and elevated decibel levels associated with excitement. In another embodiment, interaction assessment program 110 may associate the user interaction data with multiple possible sources of the deviation from an average user response. For example, interaction assessment program 110 may associate a deviation from an average user response with product features such as the sensitivity of a capacitive touch screen and the software surrounding a camera shutter button in a smartphone. By associating a deviation from an average user response to multiple product features, interaction assessment program 110 can provide a comprehensive approach to assessing one or more deviating features.

Interaction assessment program 110 records the user interaction data associated with the product and the product feature of the product (step 206). In one embodiment, interaction assessment program 110 may record the user interaction data associated with a product and a product feature of the product to database 112. In another embodiment, interaction assessment program 110 may record the user interaction data associated with a product and a product feature of the product on a first database for temporary storage until transferring the user interaction data associated with a product and a product feature of the product at a later time. For example, interaction assessment program 110 may record user interaction data associated with a product and a product feature of the product on a smartphone solid state drive on a continuous basis until interaction assessment program 110 sends the bulk data collected over the course of a month to a second database on server computer 108 on the first of every month. Interaction assessment program 110 may record the user interaction data associated with a product and a product feature of the product on different schedules depending on the product and the user. However, user interaction data associated with a product and a product feature of the product may be recorded in any manner accessible to interaction assessment program 110.

Interaction assessment program 110 may further process the recorded user interaction data establish one or more standards associated with the recorded user interaction data. In one embodiment, interaction assessment program 110 calculates a baseline of the recorded user interaction data associated with the average user response to a product feature. In another embodiment, interaction assessment program 110 applies predictive analytics, such as supervised learning classifiers, time-series forecasting, and regression analysis, to the recorded user interaction data to establish a maximum tolerable deviation threshold for a product and a product feature associated with the product.

Interaction assessment program 110 analyzes the user interaction data to identify deviations from an average user response (step 208). User interaction data may include any circumstances surrounding the deviation from an average user response. For example, when analyzing a negative user interaction, user interaction data may include any circumstances associated with the negative user interactions, such as the severity of the user response, the frequency of deviations surrounding a particular product feature, and possible solutions to address the deviating product feature. In another example, when analyzing a positive user interaction, user interaction data may include any characteristics associated with the positive user interactions, such as vocal intonation, decibel level, positive language, and facial recognition. However, interaction assessment program 110 may analyze any user interaction data surrounding a deviation from an average user response and is not limited to the embodiments mentioned herein. In one embodiment, interaction assessment program 110 may analyze a particular instance surrounding a deviation from an average user response to a product feature associated with a product. For example, interaction assessment program 110 may determine that the deviation from an average user response indicates mild frustration with the camera feature based on a light shaking of a smartphone containing a gyroscopic sensor while the camera feature is open on the smartphone. In another example, interaction assessment program 110 may determine that a deviation from an average user response indicates anger towards a product feature, such as a document recovery feature of a word processing program on a laptop after a crash, by registering a hard shaking of a user device by a gyroscopic sensor, an elevated volume and speed of speech captured by a microphone indicating a heightened state of irritation, and a facial expression indicating anger captured by a camera on the laptop.

In addition to the aforementioned embodiments, interaction assessment program 110 may analyze the historical user interaction data associated with the product and the product feature to determine a level of the issue. For example, interaction assessment program 110 may determine that the camera shutter feature of a smartphone caused twenty instances of negative deviations from an average user response in the previous twelve months with increasingly negative deviations over time. In another example, interaction assessment program 110 may determine that the camera shutter feature of a smartphone caused one recorded instance of frustration with a severely negative response indicated by sensor data, such as recorded sounds, movement data, and facial recognition data.

In yet another example, interaction assessment program 110 may determine that an initially negative deviation associated with a camera shutter feature gradually caused less deviation from an average user response over time based on one or more variables, such as user adaptation to a feature or a series of patches improving a software feature. In yet another example, interaction assessment program 110 may determine that an initially positive deviation from an average user response associated with a product feature gradually caused a less marked deviation from an average user response based on one or more variables, such as an introduction of a newer feature or loss of exclusivity surrounding a feature.

Interaction assessment program 110 determines a maximum tolerable deviation threshold (step 210). A maximum tolerable deviation may be measured from a baseline of user interaction data. A baseline of user interaction data may be determined by analyzing the historical user interaction data to find the average user response to the product and the product feature. For example, interaction assessment program 110 may average the metrics collected by sensor array 106 to establish the average user response to a particular product and a particular product feature of the product. A baseline of user interaction data may also be pre-determined by a user of interaction assessment program, such as a product manufacturer. After establishing a baseline of user interaction data, interaction assessment program 110 may determine the maximum tolerable deviation threshold. In one embodiment, interaction assessment program 110 may receive a maximum tolerable deviation threshold from a user of interaction assessment program 110, such as a product manufacturer. For example, a manufacturer of a laptop may define the maximum tolerable deviation threshold to be one deviation from an average user response every 100 times a user uses a laptop feature, such as a file transfer feature. In another example, a manufacturer of a laptop may define the maximum tolerable deviation threshold to be one time every twelve months of laptop ownership. In yet another example, a manufacturer of a laptop may assign a numerical value to the maximum tolerable deviation threshold, such as 100, and assign a numerical value to each instance of a deviation from an average user response.

In a related example, the maximum tolerable deviation threshold may be any combination of one or more of the aforementioned embodiments. In another embodiment, interaction assessment program 110 may determine a maximum tolerable deviation threshold using one or more algorithms, such as a regression analysis using a supervised learning classifier or a time series forecast. For example, interaction assessment program 110 may use a regression analysis associated with one or more supervised learning classifiers to analyze general manufacturer data to predict the average likelihood of future deviation from an average user response associated with a product feature. As a result, interaction assessment program 110 may set the maximum tolerable deviation threshold to the expected rate of deviation from an average user response to a particular product feature relative to the amount of time a user uses client device 104. In yet another example, interaction assessment program 110 may use a time-series forecast particular to a user to predict the average number of instances of deviation from an average user response associated with a product feature to expect in a given amount of time based on past instances of deviation from an average user response. However, the maximum tolerable deviation threshold may be set using any metric available and is not limited to the embodiments disclosed herein.

Interaction assessment program 110 determines whether or not the deviating feature exceeds the maximum tolerable deviation threshold (decision block 212). In one embodiment, interaction assessment program 110 may determine that the number of deviation from an average user response associated with a product feature exceeds a manufacturer set maximum tolerable deviation threshold. For example, interaction assessment program 110 may determine that ten instances of deviation from an average user response to a wireless internet connection feature on a laptop in the course of one month exceeds the manufacturer set value of nine for the particular product feature or set of product features, such as a general internet connectivity category. In another example, interaction assessment program 110 may determine that twelve instances of deviation from an average user response to a wireless internet connection feature on a laptop at a rate of one a month over the course of a year exceeds a manufacturer set maximum tolerable deviation threshold of one instance every two months over the course of a year.

In another embodiment, interaction assessment program 110 may determine that the number of deviation from an average user response associated with a product feature exceeds a maximum tolerable deviation threshold set by an algorithm, such as a time-series forecast or a regression analysis associated with one or more supervised learning classifiers. For example, interaction assessment program 110 may determine that a product and product feature that a user that initially registered one deviation from an average user response associated with a wireless internet connectivity feature on a laptop a month in the first year or ownership is now registering two instances of deviation from an average user response per month in the second year of owning the product. As a result, interaction assessment program 110 may determine that the product and product feature exceeds the maximum tolerable deviation threshold set by the time-series forecast. In another example, interaction assessment program 110 may determine that a user registered more than an average number of deviation from an average user response based on an average number of deviation from an average user response associated with internet connectivity features established by data collected by a manufacturer of a larger sample size of users. However, interaction assessment program 110 is not limited to the embodiments discussed herein and may use any method to determine whether a deviating feature exceeds the maximum tolerable deviation threshold.

Responsive to determining that the deviating feature does not exceed the maximum tolerable deviation threshold (“No” branch, decision block 212), interaction assessment program 110 returns to receive subsequent user interaction data. (step 202).

Responsive to determining that the deviating feature exceeds the maximum tolerable deviation threshold (“Yes” branch, decision block 212), interaction assessment program 110 creates a deviation report (step 214). In an embodiment, interaction assessment program 110 creates a deviation report highlighting one or more metrics surrounding the particular deviation of the product feature associated with the product and containing the interaction data, product data, and product feature data. In another embodiment, interaction assessment program 110 may include conclusions made using predictive analytics, such as time-series forecasts and regression analysis, to a user of interaction assessment program 110.

Interaction assessment program 110 sends the deviation report (step 216). In an embodiment, interaction assessment program 110 sends the deviation report to one or more manufacturers of the product containing the deviating product feature. In another embodiment, interaction assessment program 110 may not send the deviation report and store the deviation report for retrieval by a user of interaction assessment program at a later time. For example, interaction assessment program 110 may send an email regarding the creation and storage of the deviation report to a user of interaction assessment program 110 for later retrieval by the user.

FIG. 3 depicts a block diagram of components of server computer 108 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Server computer 108 can include processor(s) 304, cache 314, memory 306, persistent storage 308, communications unit 310, input/output (I/O) interface(s) 312 and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306.

Program instructions and data used to practice embodiments of the present invention, e.g., interaction assessment program 110 and database 112, are stored in persistent storage 308 for execution and/or access by one or more of the respective processor(s) 304 of server computer 108 via cache 314. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of client device 104. In these examples, communications unit 310 includes one or more network interface cards. Communications unit 310 may provide communications through the use of either or both physical and wireless communications links. Interaction assessment program 110, database 112, and other programs and data used for implementation of the present invention, may be downloaded to persistent storage 308 of server computer 108 through communications unit 310.

I/O interface(s) 312 allows for input and output of data with other devices that may be connected to server computer 108. For example, I/O interface(s) 312 may provide a connection to external device(s) 316 such as a keyboard, a keypad, a touch screen, a microphone, a digital camera, and/or some other suitable input device. External device(s) 316 can also include portable computer readable storage media such as, for example, thumb drives, portable optical or magnetic disks, and memory cards. Software and data used to practice embodiments of the present invention, e.g., interaction assessment program 110 and database 112 on server computer 108, can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor. Display 318 can also function as a touchscreen, such as a display of a tablet computer.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

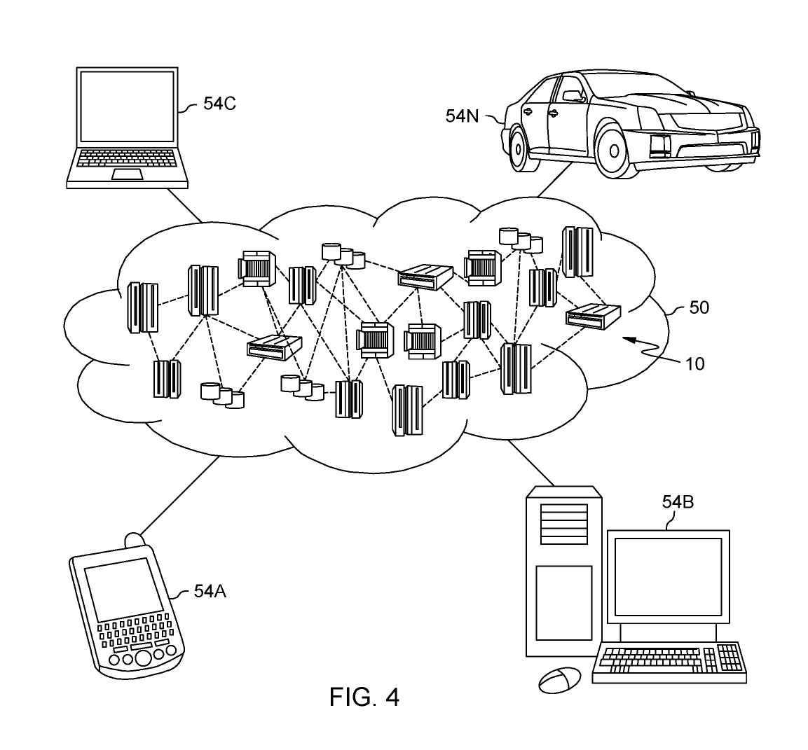

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. Server computer 108 may be one instance of node 10. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

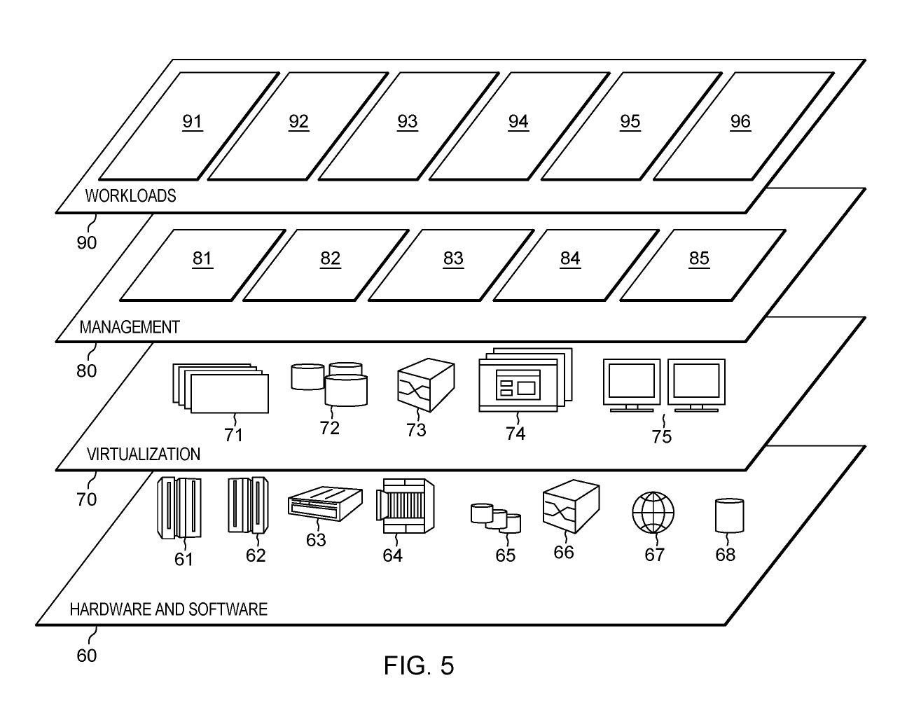

Referring now to FIG. 5, a set of functional abstraction layers provided by cloud computing environment 50 (FIG. 1) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and interaction assessment program 110.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

1. A method for analyzing user responses to features of a product, the method comprising:
receiving, by one or more computer processors, user interaction data associated with a product, wherein the user interaction data is captured using one or more sensors on the product, wherein the one or more sensors is includes at least a gyroscopic sensor, a microphone, a camera, and a biometric sensor;
recording, by the one or more computer processors, the user interaction data associated with the user interaction;
associating, by the one or more computer processors, the user interaction data with one or more product features of the product;
determining, by the one or more computer processors, the average user response to the one or more product features using the recorded user interaction data;
calculating, by the one or more computer processors, the baseline of the recorded user interaction data associated with the average user response to the one or more product features;
establishing, by the one or more computer processors, a maximum tolerable deviation threshold, wherein the maximum tolerable deviation threshold is established using a time-series forecast, a regression analysis, and using historical user interaction data associated with the product and the one or more product features;
adjusting, by the one or more computer processors, a baseline of user interaction data associated with an average user response to the one or more product features based the established maximum tolerable deviation threshold;
analyzing, by the one or more computer processors, a second user interaction data associated the one or more product features to determine if a deviation from the average user response has occurred;
in response to determining that the second received user interaction data deviates from the average user response, creating, by the one or more computer processors, a deviation report containing the received user interaction data and associated one or more product features, wherein the deviation report includes a frequency of deviations surrounding a particular product feature and possible solutions to address a deviating product feature; and
sending, by the one or more computer processors, the deviation report containing the user interaction data exceeding the maximum tolerable deviation thresh
